(19) United States
(12) Patent Application Publication
(10) Pub. No.: US 2009/0139412 A1
(43) Pub. Date: Jun. 4, 2009

(54) Rotary Double-Layer Grill

(75) Inventor: Yixin ZHAN, Fujian (CN)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(73) Assignee: Tsann Kuen (China) Enterprise Co., Ltd., Fujian (CN)

(21) Appl. No.: 12/325,741

(22) Filed: Dec. 1, 2008

(30) Foreign Application Priority Data
Nov. 30, 2007 (CN) 200720008919.0

(51) Int. Cl. A47J 37/06

(52) U.S. Cl. 99/374; 99/380

(57) ABSTRACT

A rotary double-layer grill comprises a base and a pan member, wherein the base has two brackets, and the pan member revolvably connects to the two brackets. The pan member comprises a lower pan unit, an upper pan unit and a middle pan unit, wherein the top side of the lower pan unit has a grilling surface, and the bottom side of the upper pan unit has a grilling surface. The left end of the upper pan unit and the left end of the lower pan unit form a pivot connection. Both the top side and the bottom side of the middle pan unit are grilling surfaces, and the middle pan unit is separately mounted between the upper pan unit and the lower pan unit. The pans form two grilling spaces, which can be used to grill more food simultaneously.

### FIELD OF THE INVENTION

The present invention relates to a grill, and more particularly to a rotary grill having multiple grilling spaces.

### BACKGROUND OF THE INVENTION

The existing rotary grill comprising a base and a pan member, the base has two brackets, the pan member revolvably connected to the two brackets. The pan member comprises a lower pan unit and an upper pan unit, the top side of the lower pan unit has a grilling surface. The bottom side of the upper pan has a grilling surface. The left end of the upper pan unit and the left end of the lower pan unit form a pivot connection. The grilling surface of the upper pan unit and the grilling surface of the lower pan unit forms a grilling space between them. Because there is only one grilling space, the amount of food that can be grilled each time is limited.

### SUMMARY OF THE INVENTION

The present invention obviates the disadvantages existing in the prior art that only a relatively limited amount of food can be grilled simultaneously.

This and other object of the present invention is achieved by providing: a rotary double-layer grill comprising a base and a pan member, the base has two brackets, the pan member revolvably connected to the two brackets. The pan member comprises a lower pan unit, an upper pan unit and a middle pan unit, the top side of the lower pan unit has a grilling surface. The bottom side of the upper pan unit has a grilling surface. The left end of the upper pan unit and the left of the lower pan unit form a pivot connection. Both the top side and the bottom side of the middle pan unit are grilling surfaces, and the middle pan unit is separately mounted between the upper pan unit and the lower pan unit.

In one preferred embodiment of the present invention, the left end of the lower pan unit has a groove, the left end of the middle pan unit has an inserting portion, the inserting portion inserted in the groove.

In one preferred embodiment of the present invention, the lower pan unit comprising a lower shell and a lower pan, the lower shell has a lower housing cooperating to the lower pan, the lower pan separatably mounted in the lower housing.

In one preferred embodiment of the present invention, the upper pan unit comprising an upper shell and an upper pan, the upper shell has an upper housing cooperating to the upper pan, the upper pan separatably mounted in the upper housing.

In one preferred embodiment of the present invention, the right end of the lower pan unit has a lower handle, the right end of the upper pan unit has an upper handle, the right end of the middle pan unit has a middle handle; the upper, middle, lower handles constitute the handle unit for the users.

In one preferred embodiment of the present invention, the left bracket has a hole, the right bracket has a groove opened upwardly; the left end of the lower pan unit has a shaft, the shaft pivotally connected to the hole; the handle unit removably positioned in the groove.

In one preferred embodiment of the present invention, each the upper shell and the lower shell has an electric heating tube inside.

In one preferred embodiment of the present invention, the middle pan unit has an electric heating tube inside.

In one preferred embodiment of the present invention, the grill has multiple middle pan units, each middle pan unit has different shape.

In one preferred embodiment of the present invention, the grilling space between the grilling surface of the lower pan unit and the grilling surface of the middle pan unit is different from or the same as the grilling space between the grilling surface of the middle pan unit and the grilling surface of the upper pan unit.

The advantages of the present invention are that: the middle pan added to the existed rotary grill forms double grilling spaces, which can grill more food simultaneously. Because the middle pan unit separately mounted between the upper pan unit and the lower pan unit, so it can be cleaned conveniently, after using, the pan can be detached from the grill and put into the dishwasher, and be cleaned clearly to avoid the food leavings remaining on the pan to bring bacterium. The middle pan unit of different shape can be replaced by each other to grill different food. The different or the same space of the upper and the lower grilling space can provide more choices for the users.

### BRIEF DESCRIPTION OF THE DRAWINGS

The foregoing summary, as well as the following detailed description of the preferred embodiment of the present application, will be better understood when read in conjunction with the appended drawing.

FIG. 1 is an exploded perspective view of the rotary grill of the present invention.

### DETAILED DESCRIPTION OF THE PREFERRED EMBODIMENT

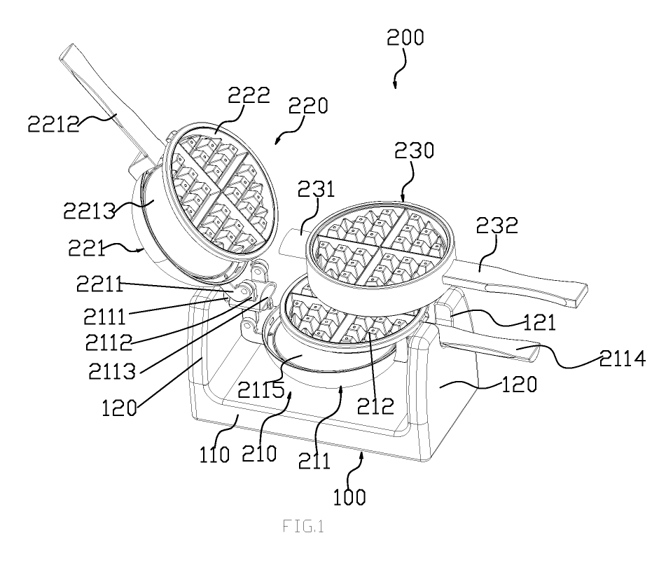

Referring to FIG. 1, it shows the exploded view of the grill in this embodiment. A rotary double-layer grill comprising a base 100 and a pan member 200.

Herein the base 100 comprising a base board 110 and two brackets 120, the left bracket 120 has a hole, the right bracket 120 has a groove 121 opened upwardly.

The pan member 200 comprising a lower pan unit 210, an upper pan unit 220 and a middle pan unit 230.

The lower pan unit 210 comprising a lower shell 211 and a lower pan 212. The left end of the lower shell 211 has a shaft 2111, a seat 2112 and an inserting groove 2113, the right end of the lower shell has a lower handle 2114, the lower shell has a lower housing 2115 opened upwardly, and an electric tube located therein for transferring heat to the pan to grill the food. The lower pan 212 separately mounted in the lower housing 2115, wherein the top of the lower pan 212 forms grilling surface.

The upper pan unit 220 comprising an upper shell 221 and an upper pan 222. There is a lug 2211 in the left end of the upper shell 221, an upper handle 2212 is in the right end of the upper shell, an upper housing 2213 is formed in the upper shell, and an electric heating tube located in the upper housing generating heat to the pan for grilling the food. The upper pan 222 separately mounted in the upper housing 2213, herein the bottom side of the upper pan 222 forms a grilling surface. The lug 2211 of the upper pan 220 pivotally connected to the seat 2112 of the lower pan unit 210, thus the upper pan unit 220 and the lower pan unit 210 form a pivot connection, herein the biggest revolving angle between the upper pan unit 220 and the lower pan unit 210 is 105 degrees.

Both the top side and the bottom side of the middle pan unit 230 are grilling surfaces, and there is electric tube embedded therein, thus forms a double-layer pan. Herein the left end of the middle pan unit 230 has an inserting portion 231, the right end of the middle pan unit has a middle handle 232. The inserting portion 231 of the middle pan unit 230 separately mounted in the groove 2113 of the lower pan unit 210, thus the middle pan unit 230 separately mounted between the upper pan unit 220 and the lower pan unit 210.

The shaft 2111 of the lower pan unit 210 separately mounted in the hole of the base 100; the lower handle 2113, upper handle 2212 and middle handle 232 of the pan member positioned in a same vertical space, and formed a handle unit for holding by users, the handle unit is removably and rotatably positioned in the groove 121 of the base 100, thus the pan member 200 horizontally span on two brackets 120 of the base 100, and forms the a rotary connection with the two brackets 120 of the base 100, herein the pan member 200 can revolving 180 degree.

There can be multiple middle pan unit 230 of different shapes depend on different cooking requirements of users. And the grilling space between the grilling surface of the lower pan unit and the grilling surface of the middle pan unit is different from or the same as the grilling space between the grilling surface of the middle pan unit and the grilling surface of the upper pan unit depend on different cooking requirements.

After the food being put on the pan, in the grilling, the user can rotate the handle to let the pan member 200 revolve 180 degrees, thus another food can be put on another pan. After using, the pan can be detached from the grill and put into the dishwasher to clean it, thus is quite convenient for the users.

Although the invention herein has been described with reference to certain particular embodiments, it is to be understood that these embodiment is merely illustrative of the principles and applications of the present invention. It is therefore to be understood that numerous modifications may be devised without departing from the spirit and scope of the present invention as defined by the appended claims.

What is claimed is:

1. A rotary double-layer grill comprising:
a base with two brackets;
a pan member revolvably connected to the two brackets;
the pan member comprising:
a lower pan unit, the top side of the lower pan unit has a grilling surface;
an upper pan unit, the bottom side of the upper pan unit has a grilling surface; the left end of the upper pan unit and the left end of the lower pan unit form a pivot connection; and
a middle pan unit, both top side and bottom side of the middle pan unit are grilling surfaces, and the middle pan unit is separately mounted between the upper pan unit and the lower pan unit.

2. The rotary double-layer grill according to claim 1, wherein the left end of the lower pan unit has a groove, the left end of the middle pan unit has an inserting portion, the inserting portion inserted in the groove.

3. The rotary double-layer grill according to claim 1, wherein the lower pan unit comprising a lower shell and a lower pan, the lower shell has a lower housing cooperating to the lower pan, the lower pan separately mounted in the lower housing.

4. The rotary double-layer grill according to claim 1, wherein the upper pan unit comprising an upper shell and an upper pan, the upper shell has an upper housing cooperating to the upper pan, the upper pan separately mounted in the upper housing.

5. The rotary double-layer grill according to claim 1, wherein the right end of the lower pan unit has a lower handle, the right end of the upper pan unit has an upper handle, the right end of the middle pan unit has a middle handle; the upper, middle, lower handles constitute the handle unit for the users.

6. The rotary double-layer grill according to claim 5, wherein the left bracket has a hole, the right bracket has a groove opened upwardly; the left end of the lower pan unit has a shaft, the shaft pivotally connects to the hole, the handle unit removably and rotatably positioned in the groove.

7. The rotary double-layer grill according to claim 1, wherein each the upper shell and the lower shell has an electric heating tube inside.

8. The rotary double-layer grill according to claim 1, wherein the middle pan unit has an electric heating tube inside.

9. The rotary double-layer grill according to claim 1, wherein the grill has multiple middle pan units.

10. The rotary double-layer grill according to claim 9, wherein each middle pan unit has a different shape.
